(19) United States
(12) Patent Application Publication
(10) Pub. No.: US 2021/0237455 A1
(43) Pub. Date: Aug. 5, 2021

(54) LIQUID EJECTION APPARATUS AND LIQUID COLLECTION CONTAINER

(71) Applicant: CANON KABUSHIKI KAISHA, Tokyo (JP)

(72) Inventors: Tetsushi ISHIKAWA, Tokyo (JP); Seiichiro YAGINUMA, Kanagawa (JP)

(21) Appl. No.: 17/161,585

(22) Filed: Jan. 28, 2021

(30) Foreign Application Priority Data
Feb. 3, 2020 (JP) 2020-016285
Jan. 7, 2021 (JP) 2021-001426

(51) Int. Cl. B41J 2/17

(52) U.S. Cl. CPC B41J 2/1721

(57) ABSTRACT

The present invention provides a liquid ejection apparatus and a liquid collection container that can suppress a decrease in productivity by reducing time required to remove an absorber from a waste liquid collection unit and time required to attach the absorber to the waste liquid collection unit. To this end, a second absorber is provided to cover partition walls in a collection unit.

### BACKGROUND OF THE INVENTION

### Field of the Invention

The present invention relates to a liquid ejection apparatus that ejects liquid and collects the ejected liquid and a liquid collection container, particularly to a liquid ejection apparatus and a liquid collection container that hold collected liquid in a waste liquid collection unit.

### Description of the Related Art

Japanese Patent Laid-Open No. 2018-039219 describes a waste liquid collection unit in which ribs bent in a hook shape are provided and which includes therein an absorber. Providing the ribs in the waste liquid collection unit suppresses leak-out of the waste liquid in the waste liquid collection unit from an inlet port of the waste liquid collection unit when the waste liquid collection unit is tilted.

In the configuration of Japanese Patent Laid-Open No. 2018-039219, the absorber included in the waste liquid collection unit is provided with slits extending from one surface of the absorber to another surface facing the one surface. Since the absorber is partially separated at the positions of the slits, in work of removing the absorber from the waste liquid collection unit and work of attaching the absorber to the waste liquid collection unit, it is difficult to achieve a stable posture of the absorber and the absorber itself tends to deform. Accordingly, work is complicated and takes time. As a result, there is a risk of a decrease in productivity.

### SUMMARY OF THE INVENTION

The present invention thus provides a liquid ejection apparatus and a liquid collection container that can suppress a decrease in productivity by reducing time required to remove an absorber from a waste liquid collection unit and time required to attach the absorber to the waste liquid collection unit.

A liquid ejection apparatus of the present invention for achieving the aforementioned object is a liquid ejection apparatus comprising: an attachable and detachable collection container that is capable of holding liquid and that includes a partition wall standing upright from a bottom surface being a bottom in a posture in use; and an absorber that is provided in the collection container and that is partitioned by the partition wall, the absorber being capable of absorbing the liquid, wherein the absorber is provided to cover the partition wall.

Further features of the present invention will become apparent from the following description of exemplary embodiments with reference to the attached drawings.

### BRIEF DESCRIPTION OF THE DRAWINGS

FIG. 1 is a perspective view illustrating a liquid ejection apparatus;

FIG. 2 is a schematic diagram illustrating a main portion of the liquid ejection apparatus;

FIG. 3 is a cross-sectional view illustrating a collection unit;

FIG. 4A is a cross-sectional view of a second waste liquid collection unit;

FIG. 4B is a cross-sectional view of the second waste liquid collection unit;

FIG. 4C is a view illustrating a second absorber;

FIG. 5 is a view illustrating the second waste liquid collection unit and the second absorber;

FIG. 6A is a cross-sectional view of a third waste liquid collection unit;

FIG. 6B is a cross-sectional view of the third waste liquid collection unit;

FIG. 6C is a view illustrating a third absorber;

FIG. 7A is a cross-sectional view of a fourth waste liquid collection unit;

FIG. 7B is a cross-sectional view of the fourth waste liquid collection unit;

FIG. 7C is a view illustrating a fourth absorber;

FIG. 8A is a view illustrating a modification example;

FIG. 8B is a view illustrating the modification example; and

FIG. 8C is a view illustrating the modification example.

### DESCRIPTION OF THE EMBODIMENTS

### First Embodiment

A first embodiment of the present invention is described below with reference to the drawings.

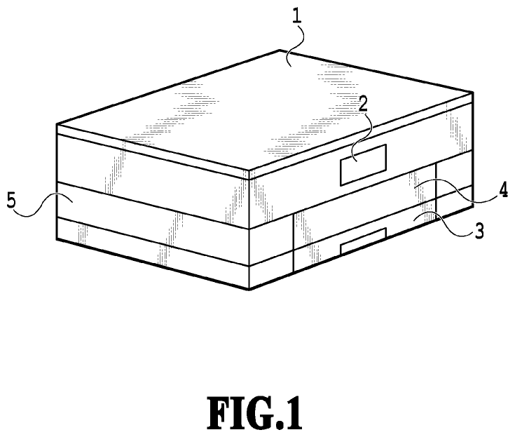

FIG. 1 is a perspective view illustrating a liquid ejection apparatus 1 in the embodiment. The liquid ejection apparatus 1 prints an image by ejecting liquid from an ejection head to a medium. The liquid ejection apparatus 1 includes a feeding tray 3 on which media to be fed to the apparatus are loaded, a printing unit 5 that performs printing on the media, a discharge tray 4 on which the media subjected to printing and discharged are stacked, and an operation panel 2 that includes various types of operation buttons and a liquid crystal display unit. The media loaded on the feeding tray 3 are fed into the apparatus and are conveyed to the printing unit 5. The printing unit 5 performs printing on the media by ejecting liquid from the ejection head to the media and then the media subjected to the printing are discharged to and stacked on the discharge tray 4.

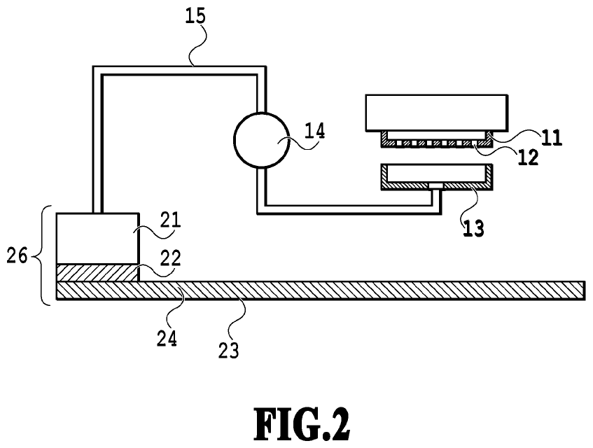

FIG. 2 is a schematic diagram illustrating a main portion of the liquid ejection apparatus 1. The liquid is ejected from multiple ejection ports 12 included in the ejection head 11. The liquid ejection apparatus 1 includes a cap 13 used to remove foreign objects in the ejection head 11 and suck the liquid in the ejection ports 12 whose viscosity has increased due to evaporation of water component in the liquid as a result of a long period of non-use and a pump 14 connected to the cap 13 via a tube 15. The liquid ejection apparatus 1 also includes a first waste liquid collection unit 21 that is connected to the pump 14 via the tube 15 and that is capable of holding the liquid and a second waste liquid collection unit 23 that is connected to the first waste liquid collection unit 21 and that is capable of holding the liquid.

The foreign objects and the liquid with increased viscosity are sucked out from the ejection ports 12 by bringing the cap 13 into contact with a surface of the ejection head 11 provided with the ejection ports 12 and driving the pump 14 to generate negative pressure in a space formed by the cap 13 and the surface provided with the ejection ports 12. The sucked-out foreign objects and the liquid with increased viscosity are collected into a collection unit 26 via the tube 15.

The collection unit 26 includes the first waste liquid collection unit 21 and the second waste liquid collection unit 23. The first waste liquid collection unit 21 includes therein a first absorber 22 and the second waste liquid collection unit 23 includes therein a second absorber 24. The first absorber 22 and the second absorber 24 are capable of absorbing the liquid. The first absorber 22 and the second absorber 24 are in contact with each other in a contact portion and the liquid absorbed by the first absorber 22 of the first waste liquid collection unit 21 is absorbed by the second absorber 24 of the second waste liquid collection unit 23 through the contact portion and is eventually collected by the second waste liquid collection unit 23.

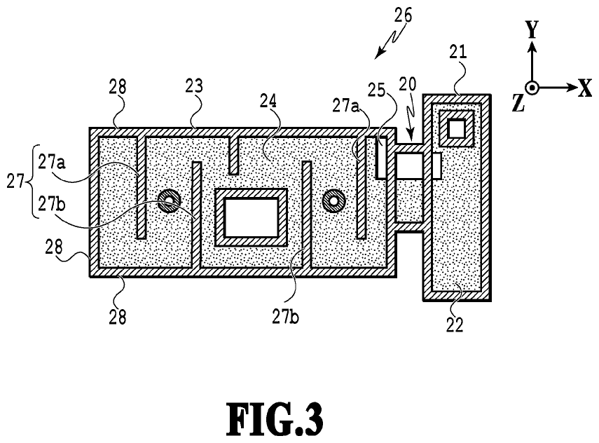

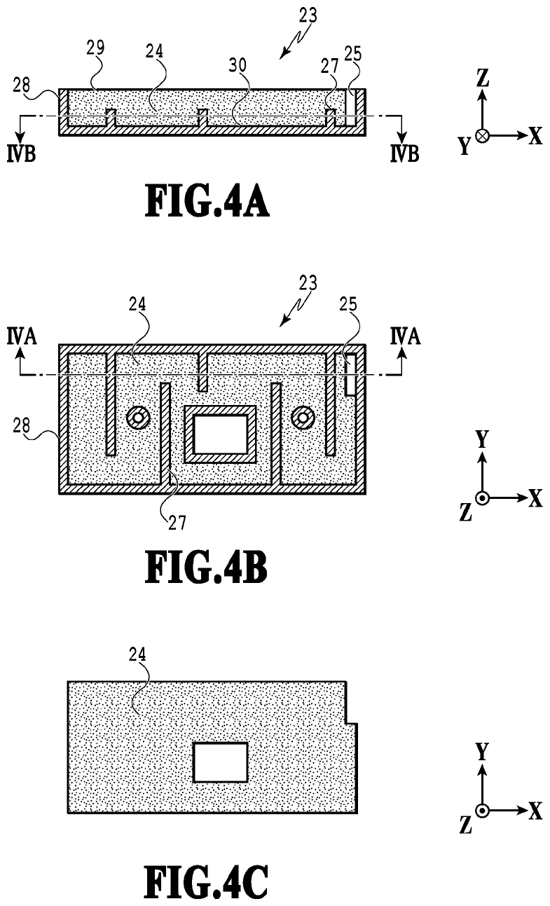

FIG. 3 is a cross-sectional view illustrating the collection unit 26. FIGS. 4A and 4B are cross-sectional views of the second waste liquid collection unit 23 and FIG. 4C is a view illustrating the second absorber 24. FIG. 4A is a cross-sectional view taken along the line IVA-IVA in FIG. 4B and FIG. 4B is a cross-sectional view of the second waste liquid collection unit 23 at the position of the line IVB-IVB in FIG. 4A. The second waste liquid collection unit 23 is connected to the first waste liquid collection unit 21 via a connection portion 20 and is provided to be detachably attached to the first waste liquid collection unit 21. Note that, in the drawings including FIGS. 4A to 4C that are referred to in the following description, illustration of the connection portion 20 is omitted.

The second waste liquid collection unit 23 includes multiple partition walls 27 that are walls standing upright in a direction of an arrow Z from a bottom surface 30 being a surface to be a bottom in a posture in use where the second waste liquid collection unit 23 is attached to the first waste liquid collection unit 21 and that are connected to side walls of a case 28 partially forming a holding unit. The partition walls 27 include partition walls 27a connected to one side wall of the case 28 of the second waste liquid collection unit 23 and partition walls 27b connected to another side wall of the case 28 that faces the one side wall and the partition walls 27a and the partition walls 27b are alternately arranged in a direction of an arrow X. The partition walls 27b are not connected to the one side wall of the case 28 to which the partition walls 27a are connected, and the partition walls 27a are not connected to the other side wall of the case 28 to which the partition walls 27b are connected.

An absorber absorbs the liquid and the absorbed liquid can move inside the absorber based on gravity and the posture of the waste liquid collection unit. Alternately arranging the partition walls 27a and the partition walls 27b in the direction of the arrow X as illustrated in FIG. 3 causes the partition walls 27 to restrict the liquid moving in the second absorber 24 from moving in the direction of the arrow X when the second waste liquid collection unit 23 is tilted.

A portion where no absorber is formed is provided inside the second waste liquid collection unit 23 as an air bleeding space 25. Providing the air bleeding space 25 facilitates escaping of air inside the second waste liquid collection unit 23 and enables efficient collection of the liquid from the first waste liquid collection unit 21. Note that the configuration may be such that there is no air bleeding space 25 and the inside of the second waste liquid collection unit 23 is filled with the second absorber 24.

As illustrated in FIG. 4A, the partition walls 27 in the embodiment are provided to have a lower height than the height of the walls of the case 28 in the direction of the arrow Z and slits 24a having substantially the same height as the partition walls 27 are provided at positions corresponding to the partition walls 27 in the second absorber 24. When the second absorber 24 is to be set into the second waste liquid collection unit 23, the second absorber 24 is set by being moved relative to the second waste liquid collection unit 23, in the opposite direction to the direction of the arrow Z. The partition walls 27 are gradually fitted to the slits 24a of the second absorber 24 from upper ends in the direction of the arrow Z with the setting of the second absorber 24. When the setting of the second absorber 24 to the second waste liquid collection unit 23 is completed, the partition walls 27 of the second waste liquid collection unit 23 are completely fitted to the slits 24a of the second absorber 24.

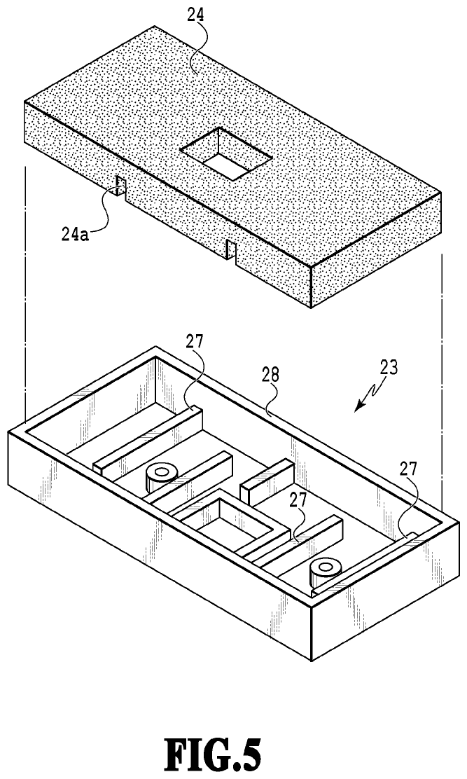

In the embodiment, the partition walls 27 are provided to have a lower height than the height of the walls of the case 28 and the slits 24a (FIG. 5) included in the second absorber 24 and configured to be fitted to the partition walls 27 are not slits that extend from one surface of the absorber to another surface opposite to the one surface. In other words, no slits configured to be fitted to the partition walls 27 are provided on an upper surface 29 that is an upper surface of the second absorber 24 in the direction of the arrow Z. Thus, when the posture of the second absorber 24 is changed in a state where the second absorber 24 is alone and is not set to the second waste liquid collection unit 23, the upper surface 29 does not deform and only curves.

Specifically, since the upper surface 29 has no slits, there are no partially separated portions and the shape of the upper surface 29 does not deform and only curves. Accordingly, when the second absorber 24 is to be attached to or removed from the second waste liquid collection unit 23, the attachment and removal can be easily performed by supporting the second absorber 24 based on the upper surface 29 (for example, supporting the second absorber 24 by holding both side surfaces opposite to each other and including long sides of the upper surface 29 opposite to each other.

The first absorber 22 and the second absorber 24 are made of materials such as non-woven fabrics represented by felts. Moreover, an upper opening of the second waste liquid collection unit 23 in the direction of the arrow Z is closed by a not-illustrated flexible film.

FIG. 5 is a view illustrating the second waste liquid collection unit 23 and the second absorber 24. Since the second absorber 24 has no slits on the upper surface 29, the second absorber 24 does not lose its posture and can be handled in a stable posture by being supported based on the upper surface 29 when removed from the second waste liquid collection unit 23 as illustrated in FIG. 5.

Note that it is only necessary that at least one partition wall 27 is provided and the heights of the partition walls 27 may vary from one another as long as they are set to be lower than the height of the walls of the case 28. Moreover, the second absorber 24 may be formed of multiple absorbers.

As described above, the second absorber 24 is provided to cover the partition walls 27 in collection means. This enables easy attachment to and removable from the second waste liquid collection unit 23. Since work is facilitated, the attachment and removable can be performed in a short time and a liquid ejection apparatus and a liquid collection container that can suppress a decrease in productivity can be provided.

A configuration in which the second absorber 24 can be removed and replaced as in the embodiment is particularly effective in a liquid ejection apparatus provided with a continuous liquid supply system in which a tank provided in the liquid ejection apparatus can be replenished with liquid from a replenishment container such as a bottle. This is due to the following reason: an usage amount of the liquid in such a liquid ejection apparatus tends to be larger than a conventional apparatus and a discharge amount of waste liquid also tends to be large with this increase in the usage amount; collection of a large amount of the waste liquid can be achieved by replacing the second absorber 24 attached to the second waste liquid collection unit 23.

### Second Embodiment

A second embodiment of the present invention is described below with reference to the drawings. Note that, since the basic configuration of the second embodiment is the same as that of the first embodiment, only the characteristic configurations are described below.

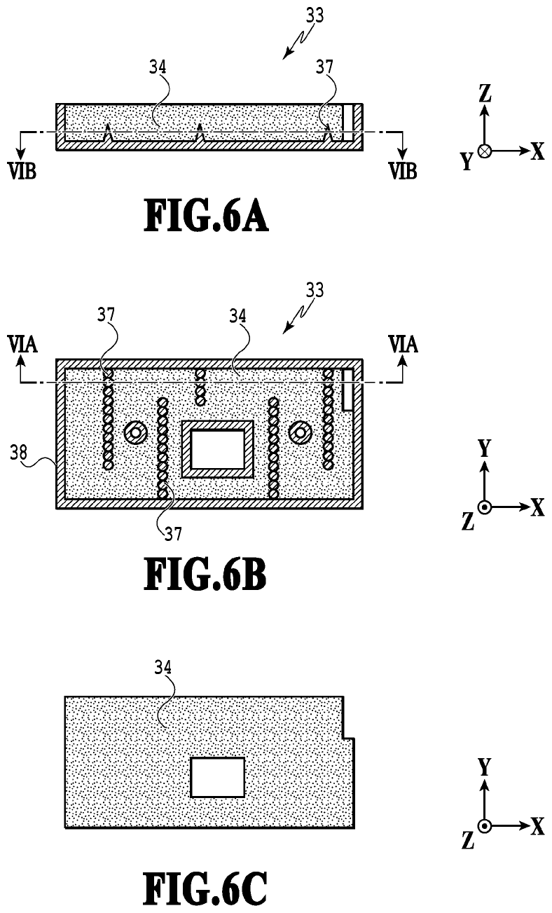

In this embodiment, a third waste liquid collection unit 33 is provided instead of the aforementioned second waste liquid collection unit 23. FIGS. 6A and 6B are cross-sectional views of the third waste liquid collection unit 33 and FIG. 6C is a view illustrating a third absorber 34. FIG. 6A is a cross-sectional view taken along the line VIA-VIA in FIG. 6B and FIG. 6B is a cross-sectional view of the third waste liquid collection unit 33 at the position of the line VIB-VIB in FIG. 6A.

Partition walls 37 of the embodiment are formed by arranging multiple protruding members (adjacent to one another) that have a height lower than the height of a wall of a case 38 and that have tips with an acute-angled conical shape or pyramid shape as illustrated in FIGS. 6A and 6B. Since the tips of the partition walls 37 have a sharp shape, the partition walls 37 pierce into the third absorber 34 from the tips when the third absorber 34 is set to the third waste liquid collection unit 33. Accordingly, no slits configured to be fitted to the partition walls 37 are provided in any of the surfaces of the third absorber 34 in the embodiment as illustrated in FIG. 6C. Thus, processing of the third absorber 34 in manufacturing is facilitated. Moreover, the third absorber 34 can be attached to the third waste liquid collection unit 33 by performing attachment only at the walls of the case 38 and attachment work is facilitated. Since base portions of the respective protruding members in the partition walls 37 are arranged without gaps between themselves and the base portions of the adjacent protruding members, the protruding members also serves a role of preventing ink leakage.

Although the example in which the partition walls 37 are formed by arranging multiple protruding members that have tips with an acute-angled conical shape or pyramid shape is described in the embodiment, the design is not limited to this. Protruding members that have tips with an acute-angled plate shape may be used.

Moreover, slits may be provided at positions corresponding to the partition walls 37 in the third absorber 34.

Since no slits are provided in the third absorber 34 also in the configuration as described in the embodiment, the third absorber 34 can be easily attached to and removed from the third waste liquid collection unit 33 and the attachment and removable can be performed in a short time. A liquid ejection apparatus and a liquid collection container that can suppress a decrease in productivity can be thereby provided.

### Third Embodiment

A third embodiment of the present invention is described below with reference to the drawings. Note that, since the basic configuration of the third embodiment is the same as that of the first embodiment, only the characteristic configurations are described below.

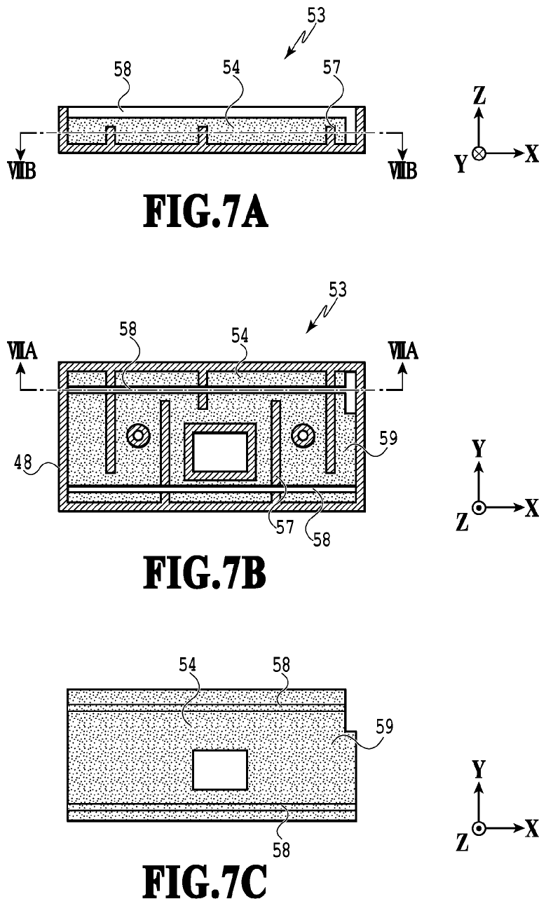

In this embodiment, a fourth waste liquid collection unit 53 is provided instead of the second waste liquid collection unit 23 and the third waste liquid collection unit 33 described above. FIGS. 7A and 7B are cross-sectional views of the fourth waste liquid collection unit 53 and FIG. 7C is a view illustrating a fourth absorber 54. FIG. 7A is a cross-sectional view taken along the line VIIA-VIIA in FIG. 7B and FIG. 7B is a cross-sectional view of the fourth waste liquid collection unit 53 at the position of the line VIIB-VIIB in FIG. 7A.

In the embodiment, the fourth absorber 54 is provided in a case 48 that forms the fourth waste liquid collection unit 53. Partition walls 57 are connected to the case 48. The partition walls 57 in the embodiment are the same as the partition walls in the first embodiment (see FIGS. 4A to 4C) as illustrated in FIGS. 7A and 7B. Moreover, slits are provided at positions corresponding to positions of the partition walls 57 in the fourth absorber 54 of the embodiment as in the first embodiment. Furthermore, recess portions 58 extending in the direction of the arrow X are provided on an upper surface (opposite surface) 59 that is an upper surface of the fourth absorber 54 in the direction of the arrow Z. Since the partition walls 57 are arranged in the direction of the arrow X, the recess portions 58 are provided to intersect the partition walls 57.

In the absorber, liquid can move and air can also move. Air moving in the absorber is guided to the air bleeding space through gaps between the absorber and the partition walls and gaps between the absorber and side walls of the waste liquid collection unit where air can move more easily than in the absorber, and is discharged from the waste liquid collection unit. Efficiently discharging air in the waste liquid collection unit as described above enables highly efficient air-liquid exchange.

However, when the height of the partition walls is lower than the height of the walls of the case, a contact area between the absorber and the partition walls is smaller than that in the case where the partition walls extend up to the same height as the walls of the case, and a region in which air can easily move becomes smaller.

Accordingly, in the embodiment, the recess portions 58 are formed in the fourth absorber 54 and are used as spaces for air bleeding and this allows efficient discharge of air. Moreover, since the recess portions 58 are provided to intersect the partition walls 57 as described above, air moving through gaps between the fourth absorber 54 and the partition walls 57 can be efficiently guided to the air bleeding space depending on the posture of the fourth waste liquid collection unit 53. Efficient discharge of air enables highly efficient air-liquid exchange and an ink collection efficiency of the fourth absorber 54 can be improved.

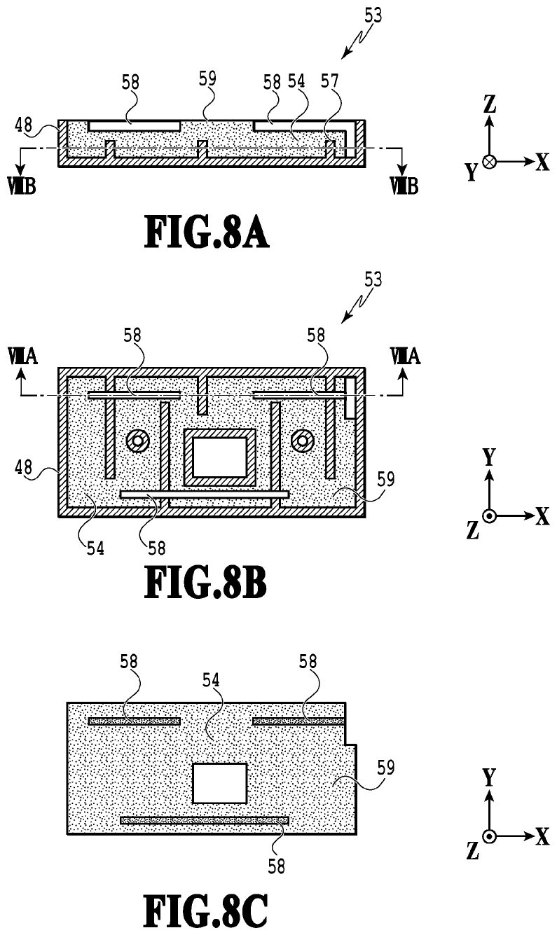

FIGS. 8A to 8C are views illustrating a modification example of the embodiment. Although the example in which the recess portions 58 are provided at two locations is described in FIGS. 7A to 7C, the configuration is not limited to this and the recess portions 58 may be provided at three locations as illustrated in FIGS. 8A to 8C. Moreover, the recess portion 58 may be provided at one location or at more than three multiple locations in the fourth absorber 54.

Although the depth of grooves of the recess portions 58 is illustrated to be large in FIGS. 7A to 7C and 8A to 8C to facilitate the understanding, the recess portions 58 do not actually have the depth in the illustration and are shallow grooves. In other words, it is only necessary to provide a space larger than a gap between the fourth absorber 54 in portions without grooves and the flexible film being the upper surface of the fourth waste liquid collection unit 53. Accordingly, the recess portions 58 do not affect the posture of the absorber in handling like the slits configured to be fitted to the partition walls.

As described above, the recess portions are provided on the upper surface of the absorber in the posture in usage. An effect of improving the ink collection efficiency of the fourth absorber 54 can be thereby also obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2020-016285 filed Feb. 3, 2020, and No. 2021-001426 filed Jan. 7, 2021, which are hereby incorporated by reference wherein in their entirety.

What is claimed is:

1. A liquid ejection apparatus comprising:
an attachable and detachable collection container that is capable of holding liquid and that includes a partition wall standing upright from a bottom surface being a bottom in a posture in use; and
an absorber that is provided in the collection container and that is partitioned by the partition wall, the absorber being capable of absorbing the liquid, wherein
the absorber is provided to cover the partition wall.

2. The liquid ejection apparatus according to claim 1, wherein the absorber includes a slit configured to be fitted to the partition wall.

3. The liquid ejection apparatus according to claim 1, wherein none of surfaces of the absorber are provided with a slit configured to be fitted to the partition wall.

4. The liquid ejection apparatus according to claim 1, wherein the partition wall is a protruding member having a tip with an acute angle.

5. The liquid ejection apparatus according to claim 4, wherein the partition wall is formed by arranging a plurality of the protruding members.

6. The liquid ejection apparatus according to claim 5, wherein base portions of the respective protruding members are arranged without gaps between themselves and the base portions of the adjacent protruding members.

7. The liquid ejection apparatus according to claim 2, wherein a recess portion is provided on an opposite surface of the absorber, the opposite surface being opposite to a surface on which the slit is provided.

8. The liquid ejection apparatus according to claim 7, wherein a plurality of the recess portions are provided.

9. The liquid ejection apparatus according to claim 1, wherein in the collection container, a height of the partition wall from the bottom surface is smaller than a height of side walls standing upright from the bottom surface and partially forming a holding unit that holds the liquid.

10. The liquid ejection apparatus according to claim 9, wherein the partition wall is connected to one of the side walls facing each other and is not connected to the other one of the side walls facing each other.

11. The liquid ejection apparatus according to claim 10, wherein the partition wall connected to the one side wall and the partition wall connected to the other side wall are alternately arranged in a direction in which the side walls extend.

12. The liquid ejection apparatus according to claim 1, wherein the absorber is made of a non-woven fabric.

13. A liquid collection container capable of holding liquid, comprising
a partition wall that stands upright from a bottom surface being a bottom in a posture in use; and
an absorber that is partitioned by the partition wall and that is capable of absorbing the liquid, wherein
the absorber is provided to cover the partition wall.
